(19) United States
(12) Patent Application Publication
(10) Pub. No.: US 2017/0229912 A1
(43) Pub. Date: Aug. 10, 2017

(54) WIRELESS POWER TRANSFER DEVICE

(71) Applicant: LG INNOTEK CO., LTD., Seoul (KR)

(72) Inventor: Su Ho BAE, Seoul (KR)

(73) Assignee: LG INNOTEK CO., LTD., Seoul (KR)

(21) Appl. No.: 15/515,360

(22) PCT Filed: Jul. 3, 2015
(86) PCT No.: PCT/KR2015/006901

§ 371 Date: Mar. 29, 2017

(30) Foreign Application Priority Data
Sep. 30, 2014 (KR) 10-2014-0130955

(51) Int. Cl. H02J 50/10; H02J 5/00

(52) U.S. Cl. CPC H02J 50/10; H02J 5/005; H02J 7/025

(57) ABSTRACT

The present invention relates to a wireless power transmission apparatus, which comprises a first transmission coil configured to operate in a first resonance frequency band; and a second transmission coil configured to operate in a second resonance frequency band, the first and second transmission coils being arranged in the same plane. According to the present invention, a wireless power transmission apparatus may transmit power efficiently.

### TECHNICAL FIELD

The present invention relates to a wireless power transmission apparatus, and more particularly to a wireless power charging system of a wireless power transmission apparatus.

### BACKGROUND ART

Generally, various electronic devices include a battery and are driven using the power charged in the battery. Here, the battery may be replaced and recharged in the electronic devices. For this, the electronic device may include a contact terminal to contact with an external charging device. That is, the electronic device is electrically connected to the charging device through the contact terminal. However, as the contact terminal of the electronic device is exposed to the outside, it may be contaminated by a foreign substance or short-circuited by moisture. In such a case, a contact failure occurs between the contact terminal and the charging device, thereby causing a problem in that a battery is not charged in an electronic device.

In order to solve the problem, there is suggested a wireless power charging system which charges the electronic device in a wireless scheme. The wireless power charging system includes a wireless power transmission apparatus and a wireless power reception apparatus. The wireless power transmission apparatus transmits power in a wireless scheme, and the wireless power reception apparatus receives power in a wireless scheme. Here, the electronic device may include a wireless power reception device, and may be electrically connected to the wireless power reception apparatus. Further, various charging methods exist in the wireless power charging system. At this time, in order that power is transferred from the wireless power transmission apparatus to the wireless power reception device, a charging method of the wireless power transmission apparatus should be same with that of the wireless power reception apparatus.

### INVENTION

### Technical Problem

Accordingly, the present invention provides a wireless power transmission apparatus which transmits power efficiently. Further, the present invention provides a wireless power transmission apparatus which transmits power according to a number of charging methods.

### Technical Solution

In order to solve the problem, a wireless power transmission apparatus of the present invention comprises a first transmission coil configured to operate in a first resonance frequency band; and a second transmission coil configured to operate in a second resonance frequency band, the first and second transmission coils being arranged in the same plane.

Further, the second transmission coil may include a number of wires.

At this time, the distance between the wires may be determined correspondingly to the first resonance frequency band.

Further, the size of the wires may be determined correspondingly to the first resonance frequency band.

Therefore, the second transmission coil may generate a parasitic capacitance correspondingly to the first resonance frequency band, blocking the power transmitted from the first transmission coil so that the power does not flow into the second transmission coil.

### Advantageous Effects

A wireless power transmission apparatus according to the present invention may transmit power according to a number of transmission methods. At this time, an interference between a first transmission coil and a second transmission coil may be prevented. That is, the second transmission coil blocks the first transmission coil so that power of the first transmission coil is not flown into the second transmission coil. Therefore, power loss of the first transmission coil may be removed by the second transmission coil. Accordingly, the wireless power transmission apparatus may transmit power efficiently.

### DESCRIPTION OF DRAWINGS

FIG. 1 is a block diagram illustrating a wireless power charging system to which the present invention applies.

FIGS. 2a, 2b, 2c, 2d and 2e are circuit diagrams illustrating equivalent circuits of a wireless transmitter and a wireless receiver in FIG. 1.

FIG. 3 is a block diagram illustrating a wireless power transmission apparatus to which the present invention applies.

FIG. 4 is an exploded perspective view illustrating a wireless transmitter according to a first embodiment of the present invention.

FIG. 5 is a circuit diagram illustrating an equivalent circuit of a wireless transmitter according to a first embodiment of the present invention.

FIG. 6 is a graph illustrating an operation characteristic of a second transmission coil in FIG. 4.

FIG. 7 is an exploded perspective view illustrating a wireless transmitter according to a second embodiment of the present invention.

FIG. 8 is a circuit diagram illustrating an equivalent circuit of a wireless transmitter according to a second embodiment of the present invention.

### BEST MODE

Hereinafter, embodiments of the present invention will be described in more detail with reference to the accompanying drawings. Here, it is noted that the same element in the accompanying drawings is denoted as the same reference numeral as far as possible. The detailed description of known function and construction unnecessarily obscuring the subject matter of the present invention will be omitted.

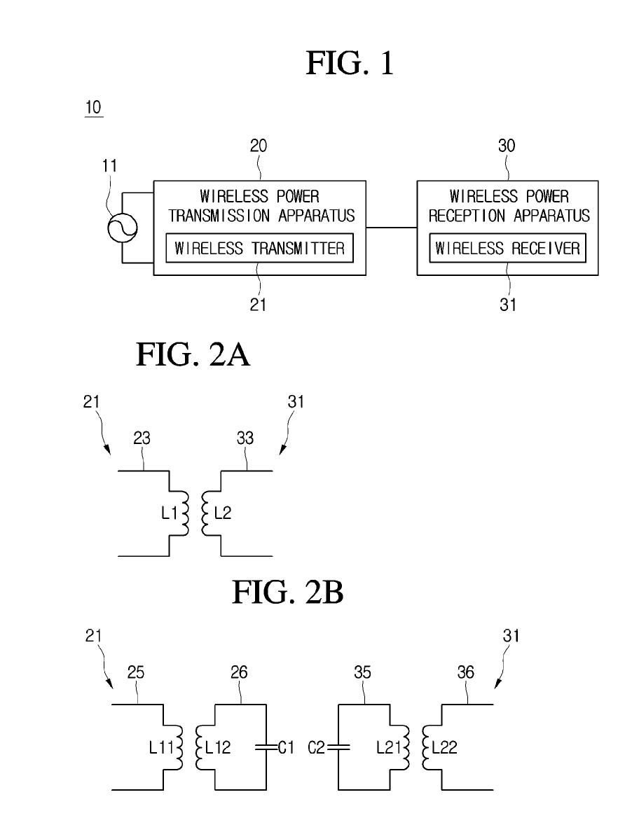

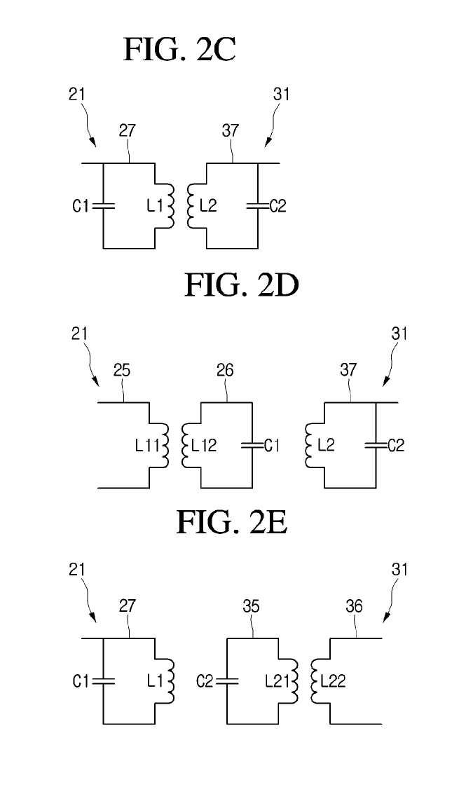

FIG. 1 is a block diagram illustrating a wireless power charging system to which the present invention applies. Further, FIGS. 2a, 2b, 2c, 2d and 2e are circuit diagrams illustrating equivalent circuits of a wireless transmitter and a wireless receiver in FIG. 1.

Referring to FIG. 1, a wireless power charging system 10 to which the present invention applies includes a wireless power transmission apparatus 20 and a wireless power reception apparatus 30.

The wireless power transmission apparatus 20 is connected to a power supply 11 to receive power therefrom. Further, the wireless power transmission apparatus 20 transmits power in a wireless scheme. Here, the wireless power transmission apparatus 20 may transmit an AC power. At this time, the wireless power transmission apparatus 20 transmits power according to a number of transmission methods. Here, the transmission methods include an electromagnetic induction method, a resonance method and a RF/Micro Wave Radiation method. That is, the wireless power transmission apparatus 20 includes at least two of the transmission method, which are set in advance. Further, the wireless power transmission apparatus 20 may select any one of the transmission methods that are set in advance, to transmit power. The wireless power transmission apparatus 20 includes a wireless transmitter 21. The wireless power reception apparatus 30 receives power in a wireless scheme. Here, the wireless power reception apparatus 30 may receive an AC power. Further, the wireless power reception apparatus 30 may convert an AC power into a DC power. At this time, the wireless power reception apparatus 30 receives power in a reception method that is set in advance. Here, the reception method includes an electromagnetic induction method, a resonance method and an RF/Micro Wave Radiation method. Further, the wireless power reception apparatus 30 may be driven using power. The wireless power reception apparatus 30 includes a wireless receiver 31.

At this time, in order that the wireless power transmission apparatus 20 transmits power to the wireless power reception apparatus 30, the wireless power reception apparatus 30 should be arranged in an area that is set in advance in the wireless power transmission apparatus 20. That is, the center of the wireless power transmission apparatus 20 should mutually correspond to that of the wireless power reception apparatus 30. Specifically, the center of the wireless power transmission apparatus 20 and that of the wireless power reception apparatus 30 should be arranged on the same line. Further, in order that the wireless power transmission apparatus 20 transmits power to the wireless power reception apparatus 30, any one of the transmission methods of the wireless power transmission apparatus 20 should be identical to the reception method of the wireless power reception apparatus 30.

For example, in case that the transmission method of the wireless power transmission apparatus 20 and the reception method of the wireless power reception apparatus are both an electromagnetic induction method, the wireless transmitter 21 and the wireless receiver 31 may be indicated as illustrated in FIG. 2a. The wireless transmitter 21 may include a transmission induction coil 23. Here, the transmission induction coil 23 may be indicated as a transmitting inductor L1. The wireless receiver 31 may include a reception induction coil 33. Here, the reception induction coil 33 may be indicated as a receiving inductor L2. Therefore, when the reception induction coil 33 is arranged opposite to the transmission induction coil 23, the transmission induction coil 23 may transmit power to the reception induction coil 33 in an electromagnetic induction scheme.

Meanwhile, the wireless power transmission apparatus 20 and the wireless power reception apparatus 30 operate in a resonance scheme, the wireless transmitter 21 and the wireless receiver 31 may be indicated as illustrated in FIGS. 2b, 2c, 2d and 2e.

The wireless transmitter 21 may include a transmission induction coil 25 and a transmission resonance coil 26 as illustrated in FIGS. 2b and 2d. Here, the transmission induction coil 25 and the transmission resonance coil 26 may be arranged opposite to each other. Further, the transmission induction coil 25 may be indicated as a first transmission inductor L11. Further, the transmission resonance coil 26 may be indicated as a second transmission inductor L12 and a transmission capacitor C1. Here, the second transmission inductor L12 and the transmission capacitor C1 are mutually connected in parallel, forming a closed loop. Alternatively, the wireless transmitter 21 may include a transmission resonance coil 27 as illustrated in FIGS. 2c and 2e. At this time, the transmission resonance coil 27 may be indicated as a transmission inductor L1 and a transmission capacitor C1. Here, the transmission inductor L1 and the transmission capacitor C1 may be mutually connected in series.

Further, the wireless receiver 31 may include a reception resonance coil 35 and a reception induction coil 36 as illustrated in FIGS. 2b and 2e. In this case, the reception resonance coil 35 and the reception induction coil 36 may be mutually arranged opposite to each other. Further, the reception resonance coil 35 may be indicated as a receiving capacitor C2 and a first receiving inductor L21. Here, the receiving capacitor C2 and the first receiving inductor L21 are mutually connected in parallel, forming a closed loop. The reception induction coil 36 may be indicated as a second receiving inductor L22. Alternatively, the wireless receiver 31 may include a reception resonance coil 37 as illustrated in FIGS. 2c and 2d. In this case, the reception resonance coil 37 may be indicated as a receiving inductor L2 and a receiving capacitor C2. Here, the receiving inductor L2 and the receiving capacitor C2 may be mutually connected in series.

Therefore, when the reception resonance coil 35 is arranged opposite to the transmission resonance coil 26, the transmission resonance coil 26 may transmit power to the reception resonance coil 35 in a resonance scheme. At this time, the transmission induction coil 25 may transfer power to the transmission resonance coil 26 in an electromagnetic induction scheme, and the transmission resonance coil 26 may transmit power to the reception resonance coil 35 in a resonance scheme. Alternatively, the transmission resonance coil 26 may directly transmit power to the reception resonance coil 35 in a resonance scheme. Further, the reception resonance coil 35 may receive power from the transmission resonance coil 26 in a resonance scheme, and the reception induction coil 36 may receive power from the reception resonance coil 35 in an electromagnetic induction scheme. Alternatively, the reception resonance coil 35 may receive power from the transmission resonance coil 26 in a resonance scheme.

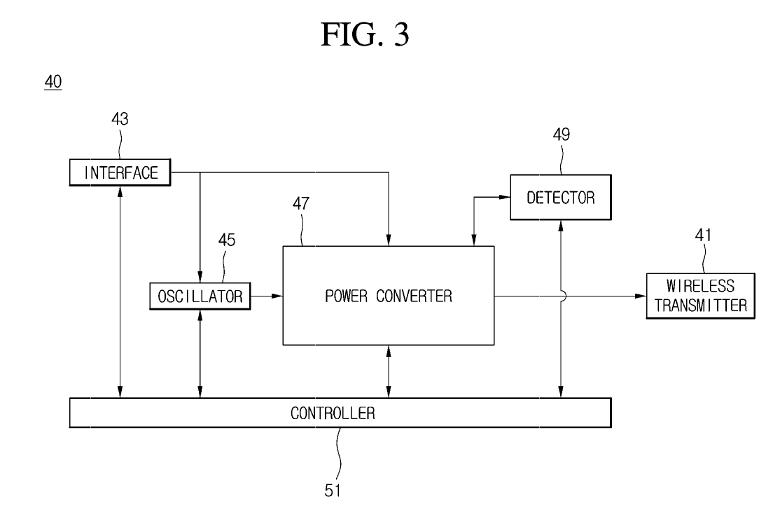

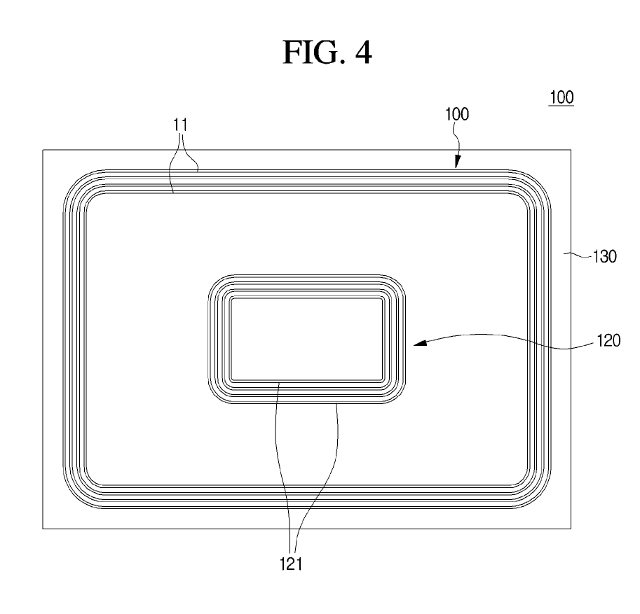

FIG. 3 is a block diagram illustrating a wireless power transmission apparatus to which the present invention applies.

Referring to FIG. 3, a wireless power transmission apparatus 40 to which the present invention applies includes a wireless transmitter 41, an interface 43, an oscillator 45, a power converter 47, a detector 49 and a controller 51.

In the wireless power transmission apparatus 40, the wireless transmitter 41 transmits power in a wireless scheme. At this time, the wireless transmitter 41 transmits power according to a number of transmission methods. Here, the transmission methods include an electromagnetic induction method, a resonance method and an RF/Micro Wave Radiation method. At this time, the wireless transmitter 41 may include a number of transmission coils. Here, the transmission coil may include at least one of a transmission induction coil and a transmission resonance coil depending on transmission methods.

In the wireless power transmission apparatus 40, the interface 43 provides an interfacing with a power source (11 of FIG. 1). That is, the interface 43 is connected to the power source 11. Here, the interface 43 may be connected to the power source 11 in a wired manner. Further, the interface 43 receives power from the power source 11. Here, the interface 43 receives a DC power from the power source 11. The oscillator 45 generates an AC signal. At this time, the oscillator 45 generates an AC signal correspondingly to a transmission method of the wireless transmitter 41. Here, the oscillator 45 generates an AC signal to have a frequency that is set in advance.

The power converter 47 converts power to provide it to the wireless transmitter 41. At this time, the power converter 47 receives a DC power from the interface 43 and an AC power from the oscillator 45. Further, the power converter 47 generates an AC power using the DC power and the AC signal. Here, the power converter 47 may amplify the AC power to use it. Further, the power converter 47 outputs the AC power to the wireless transmitter 41. The power converter 47 may be configured in a push-pull type. The push-pull type indicates a configuration that paired switches, paired transistors or paired circuit blocks alternately operate respectively, to output a response alternately.

The detector 49 detects a power transmission status of the wireless power transmission apparatus 40. Here, the detector 49 may detect an intensity of current between the power converter 47 and the wireless transmitter 41. Here, the detector 49 may detect the intensity of current at an output terminal of the power converter 47 or an input terminal of the wireless transmitter 41. The detector 49 may include a current sensor. Here, a current transformer CT may be used as the current sensor.

The controller 51 generally controls operations of the wireless power transmission apparatus 40. At this time, the controller 51 operates the wireless transmitter 41 to transmit power in a wireless scheme. Here, the controller 51 controls the power converter 47 to provide the wireless transmitter 41 with power. For this, the controller 51 operates the wireless transmitter 41 to determine whether the wireless power reception apparatus (30 in FIG. 1) exists or not. Here, the controller 51 controls the detector 49 to determine whether the wireless power reception apparatus 30 exists or not. That is, the controller 51 determines whether the wireless power reception apparatus 30 exists or not, depending on a power transmission status of the wireless power transmission apparatus 40. Further, when there exists the wireless power reception apparatus 30, the controller 51 operates the wireless transmitter 41 to transmit power in a wireless scheme. Here, the controller 51 transmits power in any one of the transmission methods. Specifically, the controller 51 selects any one of the transmission methods to transmit power.

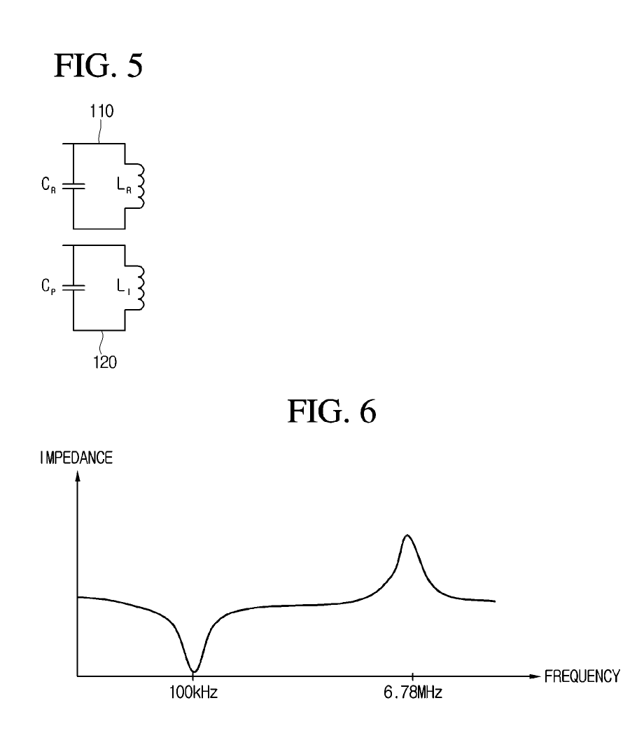

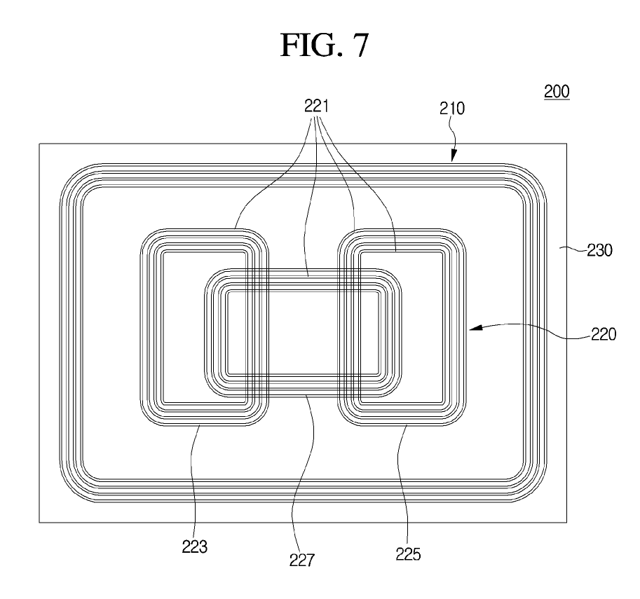

FIG. 4 is an exploded perspective view illustrating a wireless transmitter according to a first embodiment of the present invention. Further, FIG. 5 is a circuit diagram illustrating an equivalent circuit of a wireless transmitter according to a first embodiment of the present invention. Further, FIG. 6 is a graph illustrating an operation characteristic of a second transmission coil in FIG. 4.

Referring to FIG. 4, a wireless transmitter 100 of the present embodiment includes a first transmission coil 110, a second transmission coil 120 and a shield member 130.

The first transmission coil 110 operates in a first transmission method. At this time, the first transmission coil 110 transmits power in a wireless scheme according to the first transmission method. Here, the first transmission method includes an electromagnetic induction method, a resonance method and an RF/Micro Wave Radiation method. Specifically, the first transmission method may be a resonance method. Further, the first transmission coil 110 operates in a first resonance frequency band. At this time, the first transmission coil 110 transmits power in the first resonance frequency band. For example, the first resonance frequency band may be 6.78 MHz roughly.

The first transmission coil 110 includes a number of wires 111. At this time, the wires 111 may be sequentially arranged from the outside to the inside. Here, respective wires 111 may be formed in one-turn. For example, the respective wires 111 may be extended in a circular or rectangular shape. Further, as the wires 111 are arranged as closely as to the inside, the respective wires 111 may be short in their radiuses. Further, the distance between the wires 111 may be kept constant. Further, as the wires 111 are arranged as closely as to the inside, the distance between neighboring two wires may become wide or narrow gradually.

For example, when the first transmission method of the first transmission coil 110 is performed in a resonance scheme, the first transmission coil 110 may be indicated as illustrated in FIG. 6. Here, the first transmission coil 110 may include a transmission resonance coil 27 as illustrated in FIGS. 2c and 2e. Meanwhile, the first transmission coil 110 may include a transmission induction coil 25 together with a transmission resonance coil 26 as illustrated in FIGS. 2b and 2d. At this time, the first transmission coil 110 may be indicated as a resonance inductor L_{R} and a resonance capacitor C_{R}. Here, the resonance inductor L_{R} and the resonance capacitor C_{R} are mutually connected in parallel, forming a closed loop.

The second transmission coil 120 operates according to a second transmission method. At this time, the second transmission coil 120 transmits power in a wireless scheme, according to the second transmission method. Here, the second transmission method is different from the first transmission method, which includes an electromagnetic induction method, a resonance method and an RF/Micro Wave Radiation method. Specifically, the second transmission method may be an electromagnetic induction method. Further, the second transmission coil 120 operates in a second resonance frequency band. At this time, the second transmission coil 120 transmits power in a second resonance frequency band. Here, the second transmission coil 120 performs a serial resonance in the second resonance frequency band as illustrated in FIG. 5. For example, the second resonance frequency band may be 100 kHz roughly. The second transmission coil 120 includes a number of wires 121. At this time, the wires 121 may be sequentially arranged from the outside to the inside. Here, respective wires 121 may be formed in one-turn. For example, the respective wires 121 may be extended in a circular or rectangular shape. Further, as the wires 121 are arranged as closely as to the inside, the respective wires 121 may be short in their radiuses. Further, the distance between the wires 121 may be kept constant. Further, as the wires 121 are arranged as closely as to the inside, the distance between neighboring two wires 121 may become wide or narrow gradually.

Further, the second transmission coil 120 operates in a first resonance frequency band. At this time, the second transmission coil 120 generates a parasitic capacitance in the first resonance frequency band. That is, when the first transmission coil 110 operates in the resonance frequency band, the second transmission coil 120 generates a parasitic capacitance in the first resonance frequency band. Therefore, the second transmission coil 120 performs a parallel resonance in the first resonance frequency band as illustrated in FIG. 5.

For this, in the second transmission coil 120, the wires 121 are formed correspondingly to the first resonance frequency band. That is, the distance between the wires 121 and the size of the wires 121 are determined correspondingly to the first resonance frequency band. At this time, the size of the wires 121 includes the length and thickness. Further, a relationship between a parasitic capacitance and the distance between the wires 121 and the size of the wires 121 may be defined as the equation 1.

PARASITIC CAPACITANCE=ε(L*T/D) [equation 1]

Here, D denotes the distance between the wires 121, L denotes the length of the wires 121, and T denotes the thickness of the wires 121. For example, as the distance between the wires 121 becomes smaller, the value of the parasitic capacitance may increase. Further, as the length of the wires 121 becomes greater, the value of the parasitic capacitance may increase. Further, as the turn number of the wires 121 increases, the value of the parasitic capacitance may increase. Further, as the thickness of the wires 121 increases, the value of the parasitic capacitance may increase.

For example, when the second transmission method of the second transmission coil 120 is an electromagnetic induction method, the second transmission coil 120 may be indicated as illustrated in FIG. 6. Here, the second transmission coil 120 may include the transmission induction coil 23 as illustrated in FIG. 2a. At this time, the second transmission coil 120 may be indicated as an induction inductor L_{I} and a parasitic capacitor C_{P}. Here, a parasitic capacitance of the second transmission coil 120 may be indicated as the parasitic capacitor C_{P}. Further, the induction inductor L_{I} and the parasitic capacitor C_{P} are mutually connected in parallel, forming a closed loop.

At this time, the first transmission coil 110 and the second transmission coil 120 are arranged on the same plane. Here, the first transmission coil 110 and the second transmission coil 120 may be adjacently arranged to each other. Further, the first transmission coil 110 may be arranged outside the second transmission coil 120, and the second transmission coil 120 may be arranged inside the first transmission coil 110. Specifically, the first transmission coil 110 may surround the second transmission coil 120.

Further, an interference may occur from the first transmission coil 110 to the second transmission coil 120, correspondingly to the first transmission coil 110. That is, when the first transmission coil 110 transmits power in the first resonance frequency band, some power of the first transmission coil 110 may be flown into the second transmission coil 120. In other words, there occurs a magnetic flux coupling between the first transmission coil 110 and the second transmission coil 120, so that some power of the first transmission coil 110 may be lost into the second transmission coil 120.

However, the second transmission coil 120 blocks the some power of the first transmission coil 110 not to be flown into the second transmission coil 110, according to the present invention. That is, when the first transmission coil 110 transmits power in the first resonance frequency band, the second transmission coil 120 generates a parasitic capacitance. In other words, the second transmission coil 120 generates the parasitic capacitance in the first resonance frequency band. At this time, when the first transmission coil 110 is operated, an impedance of the first transmission coil 110 may be defined as the equation 2 below. Therefore, there does not occur a magnetic flux coupling between the first transmission coil 110 and the second transmission coil 120. Accordingly, some power loss of the first transmission coil 110 may be removed by the second transmission coil 120.

$${Z}_{IN} = j ω {L}_{R} + \frac{{k}^{2} {L}_{R} {L}_{I} {ω}^{2}}{{Z}_{out} \frac{j ω {L}_{I}}{1 - {ω}^{2} {L}_{I} {C}_{P}}} \qquad [ equation 2 ]$$

Here, Z_{IN} denotes an input impedance of the first transmission coil 110, Zₒᵤₜ denotes an output impedance of the second transmission coil 120, and k denotes a coupling coefficient between the first transmission coil 110 and the second transmission coil 120.

The shield member 130 separates the first transmission coil 110 and the second transmission coil 120 from each other. That is, the shield member 130 separates the first transmission coil 110 and the second transmission coil 120 from other components of the wireless power transmission apparatus (40 in FIG. 3). At this time, the shield member 130 has a material characteristic determined in advance. Here, the material characteristic includes permeability μ. Further, the permeability of the shield member 130 may be maintained in the first resonance frequency band of the first transmission coil 110 and the second resonance frequency band of the second transmission coil 120. For example, the permeability of the shield member 130 may be 100 roughly. Therefore, the loss rate of the shield member 130 may be suppressed in the first resonance frequency band of the first transmission coil 110 and the second resonance frequency band of the second transmission coil 120.

The shield member 130 supports the first transmission coil 110 and the second transmission coil 120. At this time, the shield member 130 is formed of ferrite. That is, the shield member 130 may include metal powders and a resin material. For example, the metal powders may include soft magnetic metal powders, an aluminum Al, a metal silicon and an iron oxide (FeO; Fe₃O₄; Fe₂O₃). Further, the resin material may include a thermoplastic resin, for example, a polyolefin elastomer. Here, the height of the shield member 130 may be 0.8 mm roughly.

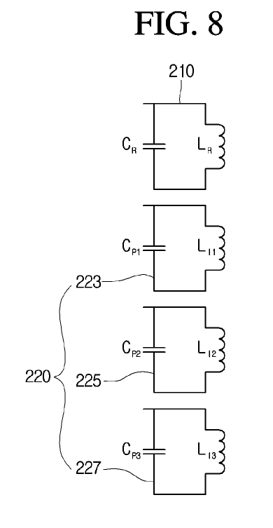

FIG. 7 is an exploded perspective view illustrating a wireless transmitter according to a second embodiment of the present invention. Further, FIG. 8 is a circuit diagram illustrating an equivalent circuit of a wireless transmitter according to a second embodiment of the present invention.

Referring to FIG. 7, a wireless transmitter 200 of the present embodiment includes a first transmission coil 210, a second transmission coil 220 and a shield member 230. At this time, since a basic configuration of the present embodiment is similar to a corresponding configuration of the above described embodiment, its detailed description is omitted. However, the second transmission coil 220 of the present invention includes a number of unit coils 223, 225 and 227. At this time, any one of the unit coils 223, 225 and 227 may be layered between the other two of the unit coils 223, 225 and 227. Further, the unit coils 223, 225 and 227 generate a parasitic capacitance in the first resonance frequency band. For this, the unit coils 223, 225 and 227 may be formed correspondingly to the first resonance frequency band. That is, the distance between the unit coils 223, 225 and 227 and the size of them may be determined correspondingly to the first resonance frequency band. At this time, the size includes radius. In other words, the distance between the coils 221 and the size of them and the distance between the unit coils 223, 225 and 227 and the size of them may be determined correspondingly to the first resonance frequency band. Therefore, as illustrated in FIG. 8, the second transmission coil 220 may perform a parallel resonance in the first resonance frequency band and a serial resonance in the second resonance frequency band.

For example, in the second transmission coil 220, respective unit coils 223, 225 and 227 may be indicated as illustrated in FIG. 8. Here, the respective unit coils 223, 225 and 227 may include the transmission induction coil 23 as illustrated in FIG. 2a. At this time, the respective unit coils 223, 225 and 227 may be indicated as induction inductors L_{I1}, L_{I2} and L_{I3} and parasitic capacitors C_{P1}, C_{P2} and C_{P3}. Here, parasitic capacitances of the respective unit coils 223, 225 and 227 may be indicated as parasitic capacitors C_{P1}, C_{P2} and C_{P3}. Further, in the respective unit coils 223, 225 and 227, the induction inductors L_{I1}, L_{I2} and L_{I3} and parasitic capacitors C_{P1}, C_{P2} and C_{P3} may be mutually connected in parallel, forming a closed loop. At this time, the second transmission coil 220 blocks some power of the first transmission coil 210 not to be flown into the second transmission coil 220, according to the embodiment of the present invention. That is, when the first transmission coil 110 transmits power in the first resonance frequency band, the second transmission coil 220 generates a parasitic capacitance. In other words, the second transmission coil 220 generates the parasitic capacitance in the first resonance frequency band. At this time, when the first transmission coil 210 is operated, the impedance of the first transmission coil 210 may be defined as the equation 2. Therefore, there does not occur a magnetic flux coupling between the first transmission coil 210 and the second transmission coil 220. Accordingly, some power loss of the first transmission coil 210 is removed by the second transmission coil 220.

According to the present invention, the wireless power transmission apparatus 40 may transmit power according to a number of transmission methods. At this time, an interference between the first transmission coils 110 and 210 and the second transmission coils 120 and 220 is prevented. That is, the second transmission coils 120 and 220 block the power of the first transmission coils 110 and 210 not to be flown thereto. Accordingly, power loss of the first transmission coils 110 and 210 is removed by the second transmission coils 120 and 220. So, the wireless power transmission apparatus 40 may transmit power efficiently.

Meanwhile, the embodiments of the present invention disclosed in the specification and drawings are presented as specific examples only, in order not to restrict the scope of the invention but to describe technical details of the present invention with ease and to help the understanding of the present invention. That is, it is obvious to those skilled in the art that other various modifications based on the technical ideas of the present invention may be embodied.

1. A wireless power transmission apparatus, comprising:
a first transmission coil configured to operate in a first resonance frequency band; and
a second transmission coil configured to operate in a second resonance frequency band, the first and second transmission coils being arranged in the same plane,
wherein the second transmission coil includes a number of wires, and
wherein the distance between the wires is determined correspondingly to the first resonance frequency band.

2. The wireless power transmission apparatus of claim 1, wherein the second transmission coil generates a parasitic capacitance correspondingly to the first resonance frequency band, blocking the power transmitted from the first transmission coil so that the power does not flow into the second transmission coil.

3. The wireless power transmission apparatus of claim 1, wherein the size of the wires is determined correspondingly to the first resonance frequency band.

4. The wireless power transmission apparatus of claim 1, wherein the second transmission coil includes a number of unit coils, and
wherein the distance between the unit coils is determined correspondingly to the first resonance frequency band.

5. The wireless power transmission apparatus of claim 4, wherein the size of the unit coils is determined correspondingly to the first resonance frequency band.

6. The wireless power transmission apparatus of claim 1, wherein the second transmission coil performs a parallel resonance in the first resonance frequency band, and a series resonance in the second resonance frequency band.

7. The wireless power transmission apparatus of claim 1, wherein the wires are sequentially arranged from the outside to the inside.

8. The wireless power transmission apparatus of claim 4, wherein any one of the unit coils is layered between the other two unit coils.

9. The wireless power transmission apparatus of claim 1, wherein the first transmission coil surrounds the second transmission coil.

10. The wireless power transmission apparatus of claim 1, wherein the first transmission coil is formed in a resonance scheme.

11. The wireless power transmission apparatus of claim 1, wherein the second transmission coil is formed in an electromagnetic induction method.

12. The wireless power transmission apparatus of claim 1, wherein the value of the parasitic capacitance increases as the distance between the wires decreases.

13. The wireless power transmission apparatus of claim 1, wherein the value of the parasitic capacitance increases as the length of the wires increases.

14. The wireless power transmission apparatus of claim 1, wherein the value of the parasitic capacitance increases as the turn number of the wires increases.

15. The wireless power transmission apparatus of claim 1, wherein the value of the parasitic capacitance increases as the thickness of the wires increases.

16. The wireless power transmission apparatus of claim 1, wherein the first resonance frequency is 6.78 MHz, and
wherein the second resonance frequency is 100 kHz.

17. A wireless power transmission apparatus, comprising:
a first transmission coil configured to operate in a first resonance frequency band; and
a second transmission coil configured to operate in a second resonance frequency band,
wherein in case that the first transmission coil operates in the first resonance frequency band, the second transmission coil generates a parasitic capacitance, to block the power generated by a magnetic flux coupling between the first and second transmission coils not to be flown into the second transmission coil.

18. The wireless power transmission apparatus of claim 17, wherein the first transmission coil includes a transmission induction coil and a transmission resonance coil, and
wherein the second transmission coil includes a transmission induction coil.

19. The wireless power transmission apparatus of claim 17, wherein the second transmission coil has wires in that the distance between the wires and the size of the wires are arranged such that the second transmission coil generates a parasitic capacitance correspondingly to the first resonance frequency band.

20. The wireless power transmission apparatus of claim 17, wherein the second transmission coil performs a parallel resonance in the first resonance frequency band, and a series resonance in the second resonance frequency band.
